(19) United States
(12) Patent Application Publication
(10) Pub. No.: US 2017/0322745 A1
(43) Pub. Date: Nov. 9, 2017

(54) INFORMATION PROCESSING APPARATUS AND METHOD OF CONTROLLING INFORMATION PROCESSING APPARATUS

(71) Applicant: FUJITSU LIMITED, Kawasaki-shi (JP)

(72) Inventor: YOSHIHISA NAKASHIMA, Kawasaki (JP)

(73) Assignee: FUJITSU LIMITED, Kawasaki-shi (JP)

(21) Appl. No.: 15/497,839

(22) Filed: Apr. 26, 2017

(30) Foreign Application Priority Data
May 6, 2016 (JP) 2016-093254

(51) Int. Cl. G06F 3/06

(52) U.S. Cl. CPC G06F 3/0631; G06F 3/0607; G06F 3/0683

(57) ABSTRACT

It is provided an information processing apparatus. The information processing apparatus includes a processor and memory storing an instruction for causing the processor to execute changing an amount of free space in main memory, determining whether data is swapped out from the main memory due to insufficient space for the free space, and setting a parameter for changing the amount of the free space in the main memory to a value to increase the amount of the free space when the determining determines that the data is swapped out from the main memory due to insufficient space for the free space.

### CROSS-REFERENCE TO RELATED APPLICATION

This application is based upon and claims the benefit of priority of the prior Japanese Patent Application No. 2016-093254, filed on May 6, 2016, the entire contents of which are incorporated herein by reference.

### FIELD

The embodiments discussed herein are related to an information processing apparatus and a method of controlling an information processing apparatus.

### BACKGROUND

Main memory directly accessed by a processor is generally more expensive than auxiliary memory in a computer. In addition, the capacity of the main memory is smaller than the capacity of the auxiliary memory. Storage space in the main memory is allocated according to a request from a program executed in the computer. However, when requests repeatedly occur in a program, there may be a case in which storage space cannot be allocated according to one of the request. In view of the case, techniques are proposed in order to increase the usage of storage space in the main memory (See Patent documents 1 and 2).

The following patent document describes conventional techniques related to the techniques described herein.

### PATENT DOCUMENT

[Patent document 1] Japanese National Publication of International Patent Application No. 2009-199478
[Patent document 2] Japanese National Publication of International Patent Application No. 2008-505389

### SUMMARY

According to one embodiment, it is provided an information processing apparatus. The information processing apparatus includes a processor and memory storing an instruction for causing the processor to execute changing an amount of free space in main memory, determining whether data is swapped out from the main memory due to insufficient space for the free space, and setting a parameter for changing the amount of the free space in the main memory to a value to increase the amount of the free space when the determining determines that the data is swapped out from the main memory due to insufficient space for the free space.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a configuration of a server according to an embodiment;

FIG. 2 is a diagram illustrating an example of a flowchart of processes executed in a server according to an embodiment;

FIG. 3 is a diagram schematically illustrating an example of free space in main memory according to an embodiment; and

FIG. 4 is a diagram illustrating an example of a flowchart of processes executed in a server according to a variation.

### DESCRIPTION OF EMBODIMENTS

In the field of High Performance Computing (HPC), it is sometimes required to execute processes by using the storage space of the main memory to the maximum extent possible. For example, a job scheduler can be used to adjust the usage of the storage space of the main memory. However, requests for using storage space exceeding the current free space may repeatedly occur during the execution of a job. In addition, each time when a request for using storage space exceeding the current free space of physical memory occurs, the request free space is allocated by swapping out the data stored in the main memory to a swap area outside the main memory. As a result, processes for swapping out the data and loading the data from the swap area to the main memory are repeated. Therefore, the processing efficiency may decrease. Embodiments are described below with reference to the drawings. Configurations of the following embodiment are exemplifications, and the present apparatus is not limited to the configurations of the embodiment.

### First Embodiment

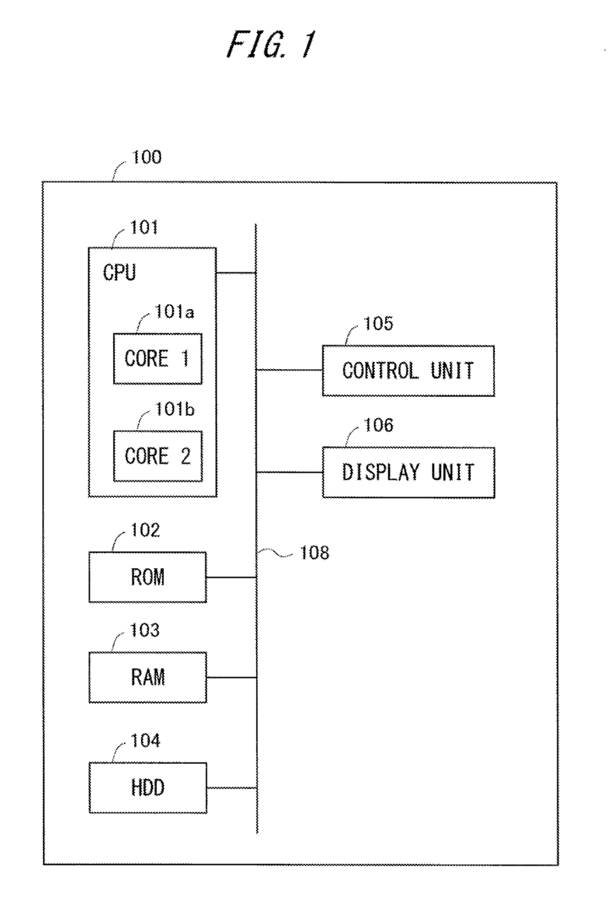

FIG. 1 schematically illustrates a configuration of a server 100 as an example of an information processing apparatus according to the first embodiment. As illustrated in FIG. 1, the server 100 includes a Central Processing Unit (CPU) 101, Read Only Memory (ROM) 102, Random Access Memory (RAM) 103, a Hard Disk Drive (HDD) 104, a control unit 105 and a display unit 106. The CPU 101 is a so-called multiple-core CPU and includes a core 1 101a and a core 2 101b. It is noted that the number of cores in the CPU is not limited to the above configuration. Each element in the server 100 is connected with each other via a bus 108.

The HDD 104 stores programs executed in the server 100. The CPU 101 deploys the programs stored in the HDD 104 on the RAM 103 to execute the processes according to instructions of the programs as described below. The ROM 102 stores kernels and firmware of the OS executed in the server 100. A user of the server 100 uses the control unit 105 to control the operations of the server 100. The display unit 106 displays execution results of the programs and various setting screens etc.

It is assumed as an example in the present embodiment that the OS executed in the server is Linux (Registered Trademark) OS. In the Linux OS, a kernel manages data on a page unit basis on the RAM 103. In addition, the pages for each process are divided into a page called “file” and a page called “anonymous”. The file page is a page allocated for data read from the auxiliary memory such as the HDD 104. And the anonymous page is a page allocated for data used in a program executed by the CPU 101.

Data same as the file pages exists in the auxiliary memory etc. when the file pages are not dirty, that is, the file pages are not overwritten. Therefore, the file pages can be reloaded from the auxiliary memory etc. even when the data of the file pages are discarded. On the other hand, it cannot be ensured that data same as the anonymous pages exists in the server 100. Therefore, when data of an anonymous page is discarded, a program cannot be executed normally in the server 100.

It is assumed in the present embodiment that the anonymous pages are not swapped out in principle. However, as an exception, the anonymous pages may be swapped out when the free space of the RAM 103 is still insufficient (scarce) after the file pages have been swapped out.

In case of Linux kernel 2.6, for example, a parameter vm.swappiness is used as a threshold for changing the frequency of memory swapping processes. It is noted that the value set to vm.swappiness is an example of a parameter for changing the amount of free space of the main memory. The value of vm.swappiness can be set to a value ranging from 0 to 100. The larger the value of vm.swappiness is, the more frequently swapping out occurs even when free space which is not used exists on the RAM 103. In addition, the ratio of the swapping out of the anonymous page and the swapping out of the file page is controlled to become the same, namely 1:1. On the other hand, when the value of vm.swappiness is set to a value such as zero which is smaller than the current value, the storage space on the RAM 103 is used as fully as possible and the frequency of the swapping out is lowered.

In this case, a swapping out process does not occur until free space does not exist on the RAM 103. That is, when a request for securing storage space larger than the free space on the RAM 103 occurs during the execution of a program, the data stored in the RAM 103 is swapped to a swap area in the auxiliary memory etc. according to the Least Recently Used (LRU) algorithm. And a process for reading the data used for the program from the swap area and writing the data into free space on the RAM 103 occurs. When the value of vm.swappiness is set to a value smaller than the current value, the amount of the free space on the RAM 103 becomes smaller. Therefore, the swapping out processes as described above repeatedly occur. As a result, the delay of the execution time of the program may be induced.

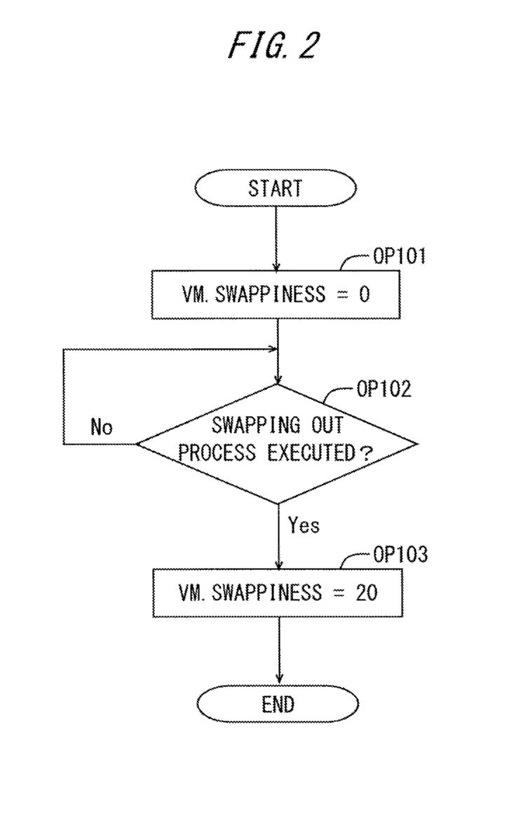

In the present embodiment, the value of vm.swappiness is changed to prevent redundant swapping out processes when a request for securing storage space larger than the free space on the RAM 103 occurs. FIG. 2 illustrates a flowchart of processes executed in the server 100. In the present embodiment, a core which is not being used or is executing a polling process among cores of CPU 101 executes the processes in the flowchart. For example, it is assumed here that a core 2 101b of the CPU 101 is executing a polling process when a core 1 101a of the CPU 101 is executing a program stored in the HDD 104. It is noted that the core 2 101b executes a swapping out process for the RAM 103. In addition, it is noted that the core 2 101b is an example of a control unit for changing the amount of the free space in the main memory.

In OP101, the core 2 101b functions as a setting unit to set the value of vm.swappiness to zero. However, the value of vm.swappiness can be set to zero as the initial value, that is the value set as a value at the startup of the server 100. Specifically, the core 2 101b changes the value of a parameter “vm.swappiness” in a file “/proc/sys/vm/swappiness” in Linux OS to zero. When the value of the parameter “vm.swappiness” is changed to zero, a swapping out process is not being executed until free space does not exist in the RAM 103. When the core 2 101b changes the value of the parameter “vm.swappiness” to zero, the process proceeds to OP102.

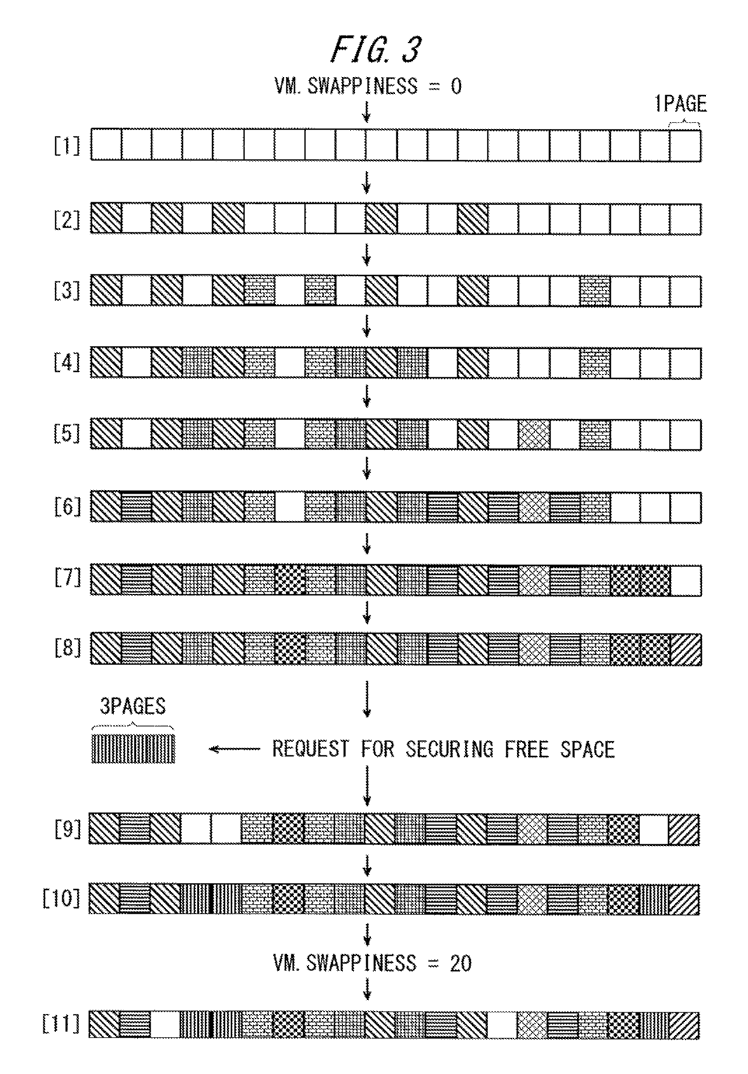

FIG. 3 illustrates an example of a usage of free space in the RAM 103 when the processes in the flowchart in FIG. 2 are executed. In FIG. 3, the state of the free space in the RAM 103 changes from a state indicated by [1] to a state indicated by [11]. In each state, space which is newly used is indicated by a pattern which is different from other patterns used in the other states. After the process in OP101 is executed, free space is secured according to the requests for securing free space in the RAM 103 from programs executed by the core 1 101a as indicated by the states from [1] to [8] in FIG. 3.

It is assumed here that a request for securing free space corresponding to three pages occurs when the state of the RAM 103 is the state as indicated by [8] in FIG. 3. Therefore, the OS kernel swaps out data in the RAM 103 the amount of which corresponds to three pages to the swap area in the HDD 104 according to the LRU. As a result, free space the amount of which corresponds to three pages is secured as indicated by the state [9] in FIG. 3.

Referring back to FIG. 2, the core 2 101b functions as a determining unit in OP102 to determine whether a process for swapping out data from the RAM 103 is executed. The core 2 101b determines that a process for swapping out data from the RAM 103 is executed (OP102: Yes), the process proceeds from OP102 to OP103. On the other hand, the core 2 101b determines that a process for swapping out data from the RAM 103 is not executed (OP102: No), the core 2 101b repeats the determination process of OP102.

In the example illustrated in FIG. 3, while the RAM 103 is in the states as indicated by the states [1] to [8], the core 2 101b repeats the determination process of OP102. And when a swapping out process regarding the RAM 103 is executed to secure free space for three pages as indicated by the state

, data used for the program currently executed is read into the secured free space as indicated by the state [10]. When the state of the RAM 103 is as indicated by the state [10], the process proceeds from OP102 to OP103.

In OP103, the core 2 101b sets the value of vm.swappiness to 20. Specifically, the core 2 101b changes the value of vm.swappiness in the “/proc/sys/vm/swappiness” file to 20. In the present embodiment, the core 2 determines that the probability that swapping out processes repeatedly occur increases when a swapping out process is executed after the core 2 receives a request for securing free space the amount of which exceeds the current amount of free space in the RAM 103. And when the value of vm.swappiness is changed to a value larger than zero, the swapping out process can secure free space in the RAM 103 before a request for securing free space the amount of which exceeds the current amount of free space in the RAM 103 occurs.

For example, the value of vm.swappiness is not changed and remains zero, the state of the RAM 103 becomes a state as indicated by [11] in FIG. 3 even when a swapping out process is executed. Therefore, when another request for securing free space in the RAM 103 occurs, a swapping out process is executed again for securing the requested free space. On the other hand, the value of vm.swappiness is changed from zero to a value larger than zero such as 20 in the present embodiment. Thus, a swapping out process is executed for securing free space with a predetermined amount in the RAM 103 the state of which is as indicated by [8] in FIG. 3.

As described above, a swapping out process is executed to securing free space in the RAM 103 in advance before a request for securing free space in the RAM 103 after a swapping out process is executed. The swapping out executed in advance increases the probability that a request for free space the amount of which exceeds the amount of the current free space in the RAM 103 can be prevented from occurring. Therefore, when a swapping out process is executed for the first time after the processes in FIG. 2 are started in the present embodiment, (1) a request for free space the amount of which exceeds the amount of the current free space in the RAM 103 occurs, (2) a swapping out process is executed for securing the free space according to the request, and (3) date is read and stored in the free space. And when the subsequent swapping out processes are executed, (1) a request for securing free space the amount of which does not exceed the amount of the current free space in the RAM 103, and (2) data is read and stored in the free space. As a result, a swapping out process is not executed when requests for securing free space occur after the first request for securing free space occurs. Therefore, the execution time according to the present embodiment can be shorter than the execution time according to the conventional techniques. When the core 2 101b completes the process in OP103, the core 2 101b terminates the processes in the flowchart.

Although specific embodiments are described above, the configurations of the server etc. described and illustrated in each example can be arbitrarily modified and/or combined. For example, the CPU 101 is a multicore CPU in the above embodiments. However, even when the server 100 includes a plurality of CPUs, a CPU which is not currently used or is currently in an inactive state can be instructed to execute the processes which are executed by the core 2 101b in the above embodiments. In addition, the core 2 101b changes the value of vm.swappiness in the “/proc/sys/vm/swappiness” file when the OS kernel detects that a swapping out process for the RAM 103 occurs in the above embodiments. However, a Daemon which is always resident in the RAM 103 can be used instead of the OS kernel to detect the occurrence of swapping out processes. Alternatively, a monitoring server can be configured separate from the server 100 to detect the occurrence of swapping out processes for the RAM 103 in place of the OS kernel.

A variation of the above embodiments is described below. It is noted in the following descriptions that elements and processes in the variation which are similar to the elements and processes in the above embodiments are attached with the same numbers and the detailed descriptions for the elements and processes are omitted.

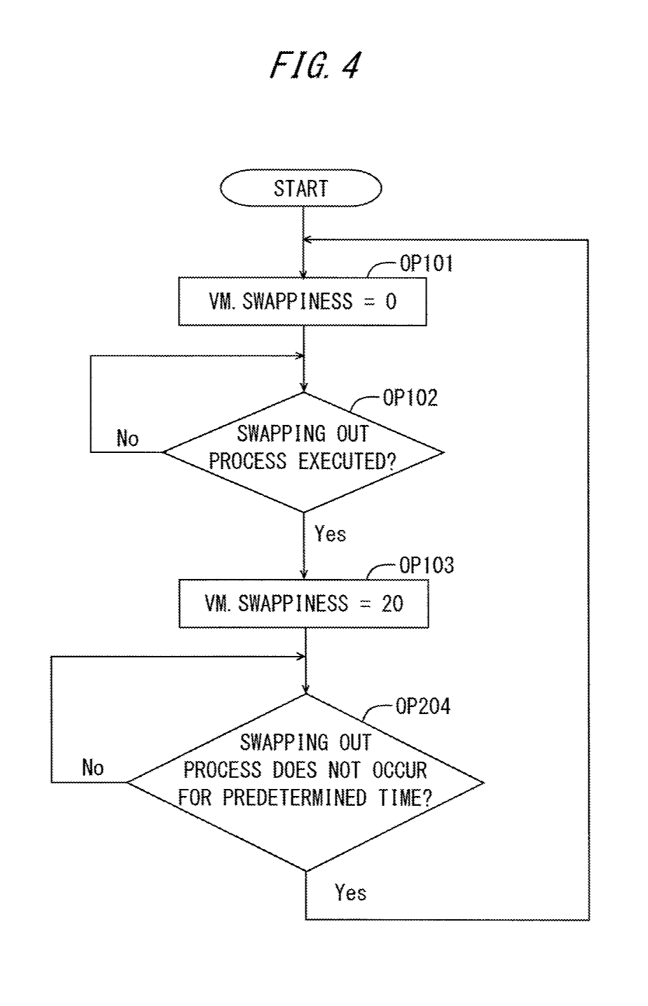

FIG. 4 illustrates an example of a flowchart of processes executed in the server 100 in the variation. It is assumed in the present variation that the core 2 101b of the CPU 101 is executing a polling process when the core 1 101a of the CPU 101 is executing a program stored in the HDD 104.

The core 2 101b executes the processes in OP101 to OP103 in a manner similar to the above embodiments. When the core 2 101b completes the process in OP103, the process proceeds to OP204. In OP204, the core 2 101b determines whether a state in which a swapping out process does not occur continues for a predetermined time period since the swapping out process is executed in OP102. The core 2 101b can be configured to use a timer to obtain the time elapsed since the occurrence of the swapping out process in OP102.

When the core 2 101b determines that a state in which a swapping out process does not occur continues for the predetermined time period since the swapping out process is executed in OP102 (OP204: Yes), the process returns to OP101. As a result, the value of vm.swappiness is set to zero again and a swapping out process is not executed until free space does not exist in the RAM 103. It is noted in the above embodiment that the value of vm.swappiness is set to 20 when a swapping out process is executed for the first time due to a request for securing free space after the value of vm.swappiness is set to zero. It is because the core 2 assumes in the above embodiments that another request for securing free space may occur in the future. However, free space which is secured in advance because the value of vm.swappiness is 20 may be left unused for the predetermined time period when a request for securing free space does not occur after the first swapping out process. In the variation, the value of vm.swappiness is set to zero again. As a result, the free space secured in advance is used for storing data while the amount of the free space in the RAM 103 is maintained to a minimum amount of space.

On the other hand, when the core 2 101b determines that the predetermined time period does not elapse since a swapping out process is executed (OP204: No), the core 2 repeats the process in OP204. Therefore, when a swapping out process is executed before the predetermined time period elapses after the swapping out process is executed in OP102, the value of vm.swappiness is maintained to be 20. It is noted that when a swapping out process is executed again after the process in OP102, the core 2 101b executes the determination in OP204 using the time elapsed since a swapping out process is executed again after OP102. As a result, the value of vm.swappiness is maintained to be 20 as long as the time interval between swapping out processes after OP102 is shorter than the predetermined time period.

As described above, the value of vm.swappiness is changed to 20 to secure free space in the RAM 103 when a swapping out process is executed for the first time since the value of vm.swappiness is set to zero according to the present embodiment. In addition, when a state in which a swapping out process does not occur continues for the predetermined time period, the value of vm.swappiness is changed to zero and a swapping out process is not executed until free space does not exist in the RAM 103. Therefore, the free space in the RAM 103 is adjusted according to the usage of the RAM 103 in a program executed in the server 100.

It is noted in the above embodiment that when a state in which a swapping out process does not occur continues for the predetermined time period, the value of vm.swappiness is changed to zero. However, a process for changing the value of vm.swappiness to zero can be executed in the above embodiment when the server 100 is rebooted or when the server is powered on after the server is powered off.

Moreover, the CPU as described above is not limited to a single processor but can be configured as multiple processors. In addition, the CPU can be configured as a multi-core processor and each CPU is connected via a single socket with each other. A part or the whole of the processes can be executed by a Digital Signal Processor (DSP), a Graphics Processing Unit (GPU), a numerical processor, a vector processor, a dedicated processor such as an image processing processor. Furthermore, at least a part of the elements in the above embodiment can be an Integrated Circuit (IC) or a digital circuit. Moreover, an analog circuit can be also used in at least a part of the elements in the above embodiment. The IC includes a Large Scale Integration (LSI), an Application Specific Integrated Circuit (ASIC), and a Programmable Logic Device (PLD). The PLD includes a Field-Programmable Gate Array (FPGA). The above parts can be a combination of a processor and an IC. The combination is referred to as Micro-Controller Unit (MCU), System-on-a-Chip (SoC), system LSI and chipset etc.

### Computer Readable Recording Medium

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM. Further, a Solid State Drive (SSD) can be used as a recoding medium which is detachable from the computer or which is fixed to the computer.

According to one aspect, it is provided an information processing apparatus which increases the processing efficiency of programs executed in the information processing apparatus in a situation in which data is swapped out from the main memory.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a processor; and
memory storing an instruction for causing the processor to execute:
changing an amount of free space in main memory;
determining whether data is swapped out from the main memory due to insufficient space for the free space; and
setting a parameter for changing the amount of the free space in the main memory to a value to increase the amount of the free space when the determining determines that the data is swapped out from the main memory due to insufficient space for the free space.

2. The information processing apparatus according to claim 1, wherein
the determining determines whether a state in which data is not swapped out from the main memory continues for a predetermined time period since the data is swapped out from the main memory, and
the setting sets the parameter to a value to maintain the amount of the free space to a minimum amount of space when the determining determines that the state in which data is not swapped out from the main memory continues for the predetermined time period since the data is swapped out from the main memory.

3. The information processing apparatus according to claim 1, wherein
the setting sets the parameter to the value to maintain the amount of the free space to a minimum amount of space when the information processing apparatus is powered on after the determining determines that the data is swapped out from the main memory.

4. A method of controlling an information processing apparatus, the method comprising:
changing an amount of free space in main memory of the information processing apparatus;
determining whether data is swapped out from the main memory due to insufficient space for the free space; and
setting a parameter for changing the amount of the free space in the main memory to a value to increase the amount of the free space when the determining determines that the data is swapped out from the main memory due to insufficient space of the free space.

5. The method according to claim 4, wherein
the determining determines whether a state in which data is not swapped out from the main memory continues for a predetermined time period since the data is swapped out from the main memory, and
the setting sets the parameter to a value to maintain the amount of the free space to a minimum amount of space when the determining determines that the state in which data is not swapped out from the main memory continues for the predetermined time period since the data is swapped out from the main memory.

6. The method according to claim 4, wherein
the setting sets the parameter to the value to maintain the amount of the free space to a minimum amount of space when the information processing apparatus is powered on after the determining determines that the data is swapped out from the main memory.

7. A non-transitory computer-readable recording medium storing a program that causes an information processing apparatus execute:
changing an amount of free space in main memory of the information processing apparatus;
determining whether data is swapped out from the main memory due to insufficient space for the free space; and
setting a parameter for changing the amount of the free space in the main memory to a value to increase the amount of the free space when the determining determines that the data is swapped out from the main memory due to insufficient space of the free space.

8. The non-transitory computer-readable recording medium according to claim 7, wherein
the determining determines whether a state in which data is not swapped out from the main memory continues for a predetermined time period since the data is swapped out from the main memory, and
the setting sets the parameter to a value to maintain the amount of the free space to a minimum amount of space when the determining determines that the state in which data is not swapped out from the main memory continues for the predetermined time period since the data is swapped out from the main memory.

9. The non-transitory computer-readable recording medium according to claim 7, wherein
the setting sets the parameter to the value to maintain the amount of the free space to a minimum amount of space when the information processing apparatus is powered on after the determining determines that the data is swapped out from the main memory.
